(19) United States
(12) Patent Application Publication
(10) Pub. No.: US 2018/0141143 A1
(43) Pub. Date: May 24, 2018

(54) METHOD AND DEVICE FOR THE AUTOMATED MACHINING AND TESTING OF GEAR COMPONENTS

(71) Applicant: Klingelnberg AG, Zurich (CH)

(72) Inventors: Martin Schweizer, Rastatt (DE); Frank Seibicke, Bad Herrenalb (DE)

(21) Appl. No.: 15/817,783

(22) Filed: Nov. 20, 2017

(30) Foreign Application Priority Data
Nov. 21, 2016 (EP) 16199812.5

(51) Int. Cl. B23F 23/12

(52) U.S. Cl. CPC B23F 23/12; B23Q 17/20

(57) ABSTRACT

A method for automated machining of gear components, comprising machining a gear component in a gear-cutting machine, performing an inline test of the gear component, wherein the inline test provides at least one test value, and comparing the at least one test value with at least one default value, and if the result of the comparison is positive, then outputting the gear component as a good part, and if the result of the comparison is negative, then transferring the gear component to an external measuring device for carrying out an offline measurement, performing the offline measurement of the gear component, wherein the offline measurement provides at least one measured value, and comparing the measured value with the test value, and if the comparison detects a deviation of the measured value from the at least one test value, then automatically making an adaptation of the inline test.

### CROSS REFERENCE TO RELATED APPLICATIONS

This application claims priority under 35 U.S.C. §§ 119(a)-(d) to European patent application no. EP16199812.5 filed Nov. 21, 2016, which is hereby expressly incorporated by reference as part of the present disclosure.

### FIELD OF INVENTION

The invention relates to a method and devices for the automated machining and testing of gear components.

### BACKGROUND

In FIG. 1, a schematic view is shown of a prior-art gear-cutting machine 10 (e.g. a gear milling machine or a gear grinding machine) and a measuring device 20 (here in the form of a separate measuring device) of the prior art (e.g. a coordinate measuring device). In the example shown, the machine 10 and the measuring device 20 form a type of production line whose further components are a memory 11 and a software SW. The memory 11 and the software SW are shown here as external components, although they can be arranged for example in the machine 10 or the measuring device 20. The memory 11 and the software SW can be coupled to the machine 10 and the measuring device 20 for communication purposes, as indicated by the dashed double arrow 12. This type of constellation is called a closed-loop constellation.

The software SW can be part of a (machine) control unit, for example. The software SW can also be installed in a computer 13, for example, which is in communication with the overall device 100.

The handling of the components BT is shown in FIG. 1 and in all other figures in the form of solid arrows. The transfer of the components BT from the machine 10 to the measuring device 20 is represented, for example, by the arrow 15. The solid arrow 15 essentially designates a handling connection between the machine 10 and the measuring device 20. Two curved arrows, which are arranged like a switch 16, are shown on the right of the measuring device 20. This switch 16 is intended to symbolize that the measuring device 20 makes it possible to differentiate between the good parts GT and the reject parts AT.

The term “coupling” is used here to indicate that the machine 10, the measuring device 20, the memory 11 and the software SW are coupled at least from a communication standpoint (i.e. for data exchange). This communication-related coupling (also called networking) presupposes that the machine 10, the measuring device 20 and the memory 11 understand the same or a compatible communication protocol and that all three follow certain conventions as far as the data exchange is concerned. The SW software should have access to the communication sequences.

As indicated in FIG. 1, a computer 13 with a display 14 can be connected to the production line and/or the memory 11 in order to load data of a gear component to be machined, for example.

In spite of the aforementioned communication-related coupling and the handling connection 15, the measuring device 20 concerns a measuring device which is used offline. Since the measurements which are carried out in such a measuring device 20 on a component BT are time-consuming, such measurements are usually carried out on individual components BT in series production in order to check from time to time whether the specified production tolerances are observed.

The measurement of a component BT in the measuring device 20 supplies actual data of the relevant component BT. These actual data can, for example, be compared with target data stored in the memory 11 by the software SW. If the measurement results in a deviation of the actual data from the target data, corrections of the machine setting of the machine 10 can be carried out for example. Components BT, which do not correspond to the target data (±tolerances), can be discarded here, for example, as a reject part AT.

Such a closed-loop approach provides highly accurate results and is therefore used today in industrial production. However, depending on the implementation, the closed-loop approach has the drawbacks briefly outlined below:

Deteriorations occurring in the characteristics to be monitored are detected only with a delay, since individual components are measured only at relatively large intervals. This results in increased rejects in case of malfunctions of the machine or the process.

Subsequent analysis of interrelationships between machine or process variables and the component quality are either only possible with considerable additional effort.

For the majority of the components there is no documentation of the component quality since only a small subset of components is measured.

### SUMMARY

It is an object of the invention to provide a device and a corresponding method which make it possible to increase the throughput in the machining of gear components without having to make sacrifices in terms of quality.

According to at least some embodiments, a method relates to the automated machining of gear components in an overall device. This method may comprise the following steps:

a) machining a gear component in a gear-cutting machine of the overall device,

b) performing an inline test of the gear component in the overall device after machining, wherein the inline test is performed in an inline test device located in or on the gear-cutting machine, or wherein the inline test is performed in a separate inline test device and provides at least one test value,

c) carrying out a comparison of the at least one test value with at least one default value,

d) if step c) is positive, then outputting the gear part as a good part,

e) if step c) is negative, then

f) transferring the gear component to an external measuring device for carrying out an offline measurement of the overall device,

g) performing the offline measurement of the gear component, wherein the offline measurement provides at least one measured value,

h) performing a comparison of the at least one measured value with the at least one test value,

i) if step h) results in a deviation of the measured value from the test value, or a deviation outside a predetermined limit, then automatically making an adaptation of the inline test.

At least some embodiments relate to an overall device which is designed for the automated machining of gear components. This overall device comprises:

a gear-cutting machine for machining a series of gear components,

a first measuring device adapted to perform an inline test of each component previously machined in the machine,

a second measuring device adapted to perform an off-line measurement of a part of the components previously tested in the first measuring device, and

a loop, as well as

a software adapted to perform the following steps for each component:

carrying out a first comparison of at least one test value, which was provided by the first measuring device, with at least one default value,

triggering the output of the corresponding gear component as a good part if the performance of the first comparison is positive,

transferring the corresponding gear component to the second measuring device for performing the offline measurement if the first comparison is not positive,

carrying out a second comparison of at least one measured value provided by the second measuring device with the at least one test value,

automatically making an adaptation of the inline test and/or the first measuring device via the loop if the second comparison results in a deviation of the at least one measured value from the at least one test value, or a deviation outside of a predetermined limit.

At least some embodiments are based on a rapid inline test with external matching so as to be able to permanently check the quality of the inline test and, if necessary, correct it.

The offline measurement may be used in at least some embodiments for the final recognition of reject parts and for deciding whether an automated adaptation of the inline test is to be carried out.

The overall device of at least some embodiments is a device which serves as part of a production line, or is designed as a production line. A corresponding overall device is distinguished by the fact that it operates in a clock-based manner. This means that the individual components of the overall device operate within the time frame (basic clock rate), which is defined by the clocking of the overall device. Individual components that process and test components in series can have specific clock times that are less than or equal to the basic clock rate.

Optionally, in at least some embodiments, the offline measurement can also be used to make a correction of the machining operation.

In at least some embodiments, step h), which relates to performing a comparison of the measured value with the test value, can either make a direct comparison of the measured value with the test value, if the inline test provides at least one test value which is comparable to a measured value of the offline measurement. Or this step h) comprises an indirect comparison of the measured value with the test value. An indirect comparison is understood here as a method which treats the at least one test value as a raw datum or raw value. The raw datum or the raw value may be subjected to further processing to obtain at least one prepared test value. Only then can a comparison of the measured value with the prepared test value be carried out.

The indirect comparison of at least some embodiments thus comprises a sub-step for computationally processing the test values obtained as raw data or raw values. This computational processing is carried out so that a measured value can then be related to the prepared test value. The relating can then comprise a direct comparison of the measured value with the conditioned test value for example, or the prepared test value is considered as a prognosis of a specific property of the gear component, and this prognosis is validated in the context of the offline measurement. This means that the measured value of the offline measurement is used to verify the prognosis. If the prognosis can be verified, the offline measurement has confirmed that the inline test was correct.

In at least some embodiments, the automated adjustment of the inline test may include one or more of the following steps:

(re-)adjustment of an inline test device used to perform the inline test, or

calibration of an inline test device used to perform the inline test,

gauging of the inline test device, or

adaptation in the case of a computational preparation or processing of the first test value, or

adaptation of a threshold value of the inline test device, or

predetermination of an offset of the inline test device, or

adaptation of test criteria of the inline test device.

The use of a test routine within the scope of the inline test is advantageous for at least some embodiments because it immediately and directly affects the quality of the components and can thereby significantly reduce the reject rate.

In at least some embodiments, a routine check of the inline test can be carried out by means of an external offline measurement in order to enable an automatic adjustment even if, for a certain time, no components have been subjected to an offline measurement as preliminary reject parts. Such a routine check can, for example, be realized by means of a counter which counts the number of the performed inline tests. One offline measurement can be carried out for each n^{th} inline test, for example.

Advantageous embodiments of the coordinate measuring device are further described herein.

### BRIEF DESCRIPTION OF THE DRAWINGS

Exemplary embodiments are described in more detail below with reference to the drawings.

FIG. 1 shows a schematic view of a gear-cutting machine and a measuring device of the prior art which are connected to one another in terms of communication technology;

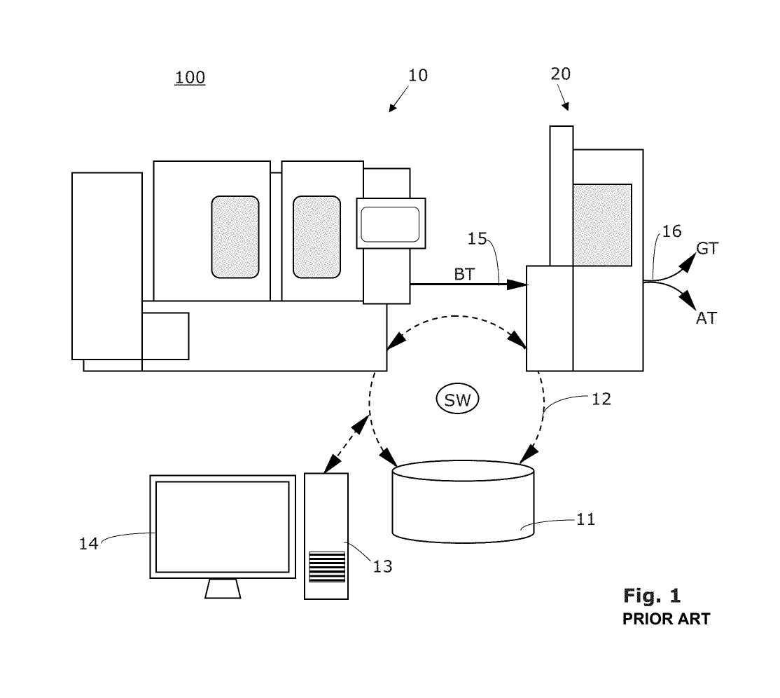

FIG. 2 shows a schematic view of an exemplary production line of an embodiment, comprising a gear-cutting machine having an integrated measuring device for performing an inline test and an external measuring device for performing an offline measurement;

FIG. 3 shows a schematic view of another exemplary production line of an embodiment, comprising a gear-cutting machine, a first external measuring device for performing an inline test, and a second external measuring device for performing an offline measurement;

FIG. 4 shows a schematic flowchart of a first method of an embodiment;

FIG. 5 shows a schematic flowchart of a second method of an embodiment.

### DETAILED DESCRIPTION

In the context of the present disclosure, terms are used which are also used in relevant publications and patents. It should be noted, however, that the use of these terms is merely intended to provide a better understanding. The inventive concept and the scope of protection of the claims are not to be limited by the specific choice of the terms. The invention can be readily applied to other conceptual systems and/or subject areas. In other subject areas, the terms shall be applied mutatis mutandis.

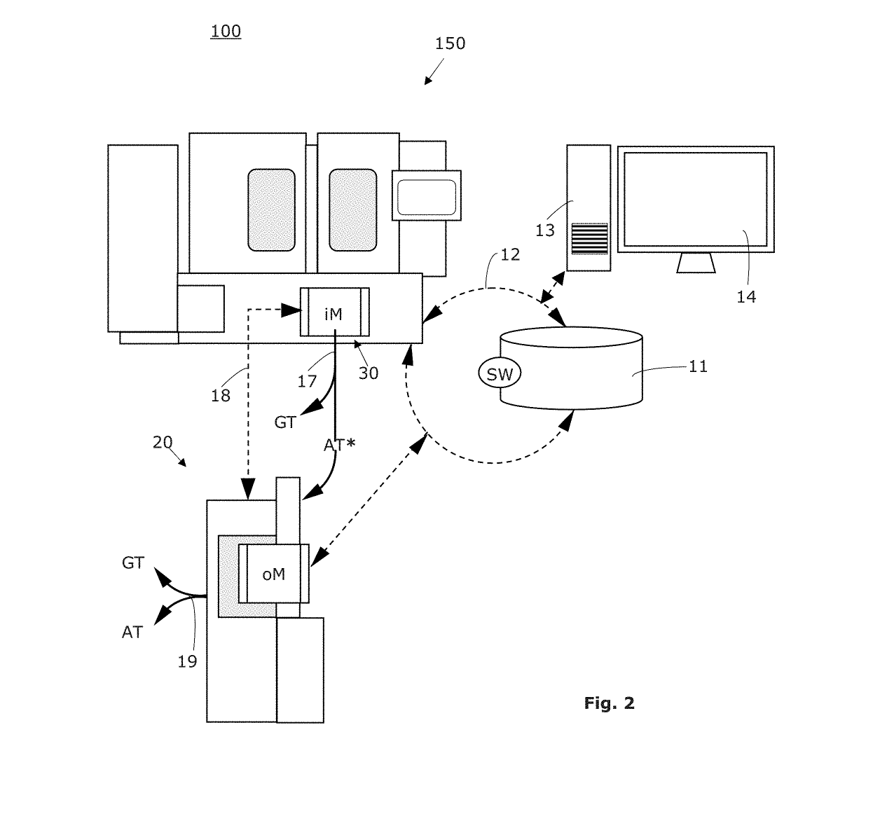

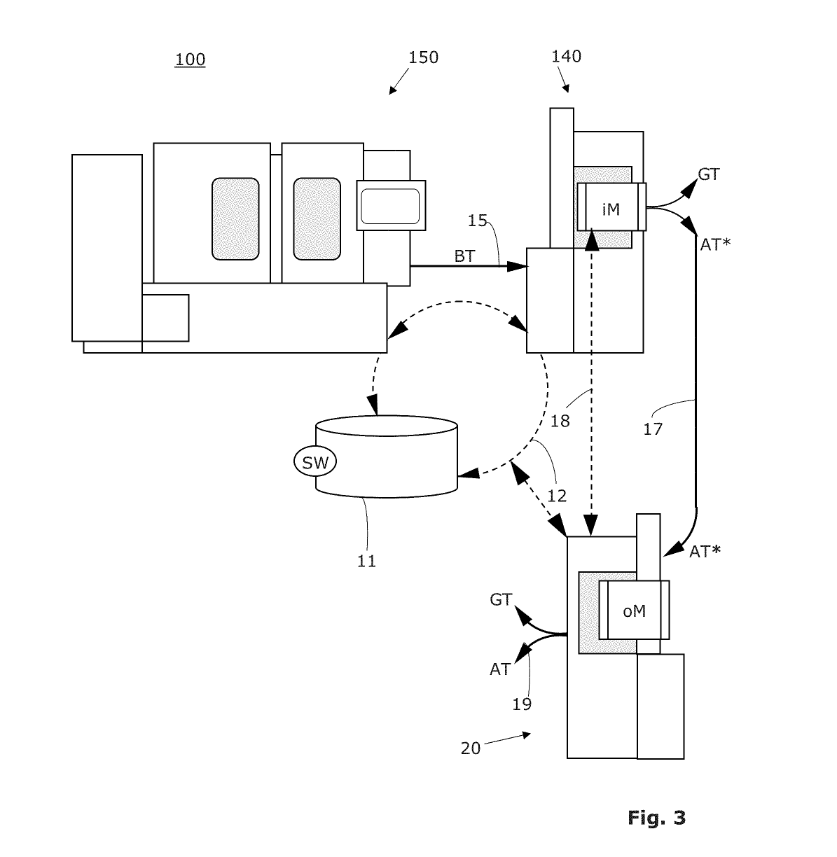

In at least some embodiments, which are shown in FIGS. 2 and 3, a production line 100 (also referred to as an overall device 100) is provided, comprising at least one gear-cutting machine 150 and a measuring device for performing an inline test iM. This measuring device can be part of the gear-cutting machine 150, as schematically indicated in FIG. 2 in that a functional block iM is provided in the region of the gear-cutting machine 150 and is provided with the reference numeral 30. As an alternative, the measuring device can be designed as an external measuring device, as schematically indicated in FIG. 3 in that a measuring device 140, which comprises a function block iM, is located next to the gear-cutting machine 150.

This means that the measuring device 30 or 140, which is also referred to herein as an inline test device, can be arranged either in or on the gear-cutting machine 150 (e.g. as an integrated measuring device in the working area of the gear-cutting machine 150), or it may, for example, be designed as a free-standing measuring device 140. In any case, the handling of the gear components BT in the production line 100 is automated in such a way that each gear component BT of a series of components is subjected to an inline test iM during or after the machining in the gear-cutting machine 150.

An inline test iM is designated as a test of components BT which is fast enough to be carried out in the clock rate of series production.

This means that a measuring device 30 or 140 is designated here as an inline test device whose clock speed is faster or the same as the clock speed of the production line 100. The slowest link of such a production line 100 defines the clock speed of the entire line. If, for example, the loading of the gear-cutting machine 150 with a gear component BT takes 2 seconds, the machining in the gear-cutting machine 150 8 seconds and the transfer of the toothed wheel component BT to the inline test device 130 2 seconds, this section of the production line 100 releases a machined component BT every 12 seconds. In order that the inline test device 130 is able to subject such a component BT fast enough to an inline test iM, the clock time of the inline test device 130 may be less than or equal to 12 seconds, in order to provide a simple example.

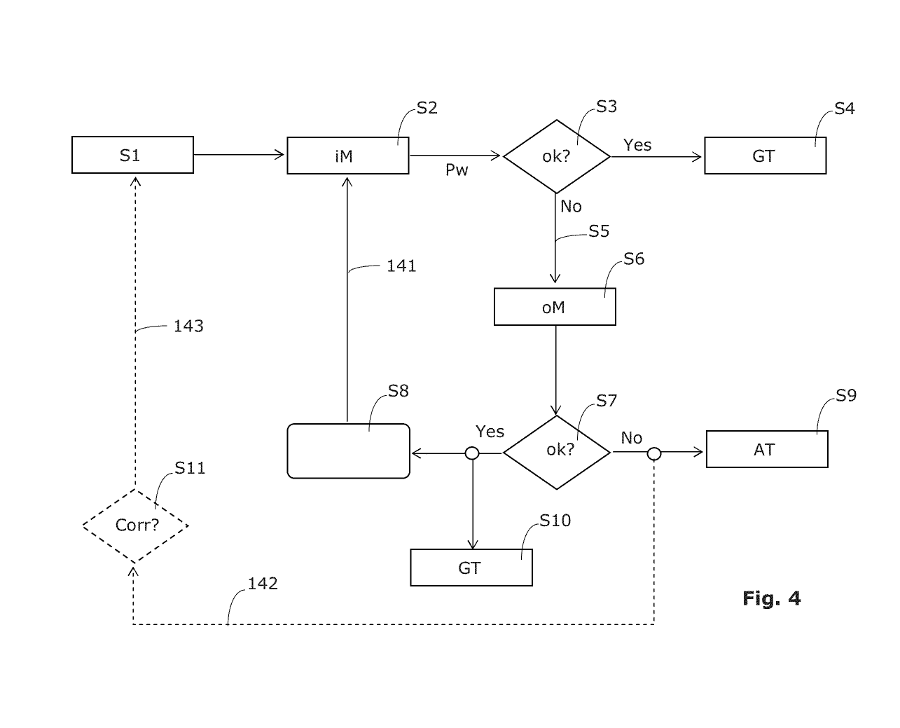

FIG. 4 shows a flow chart of the steps of a method of an embodiment. In the following, reference is made, inter alia, to FIG. 4.

The method for the automated machining of gear components BT comprises the following steps according to at least some embodiments (from the use of lower-case letters in alphabetical order, no compulsory chronology of the steps is to be derived):

a) machining a gear component BT in a gear-cutting machine 150 (step S1);

b) performing an inline test iM (step S2) of the gear component BT after machining S1, wherein the inline test iM provides at least one test value Pw,

c) performing a comparison (step S3) of the at least one test value Pw with at least one default value Vw (e.g. with a setpoint value),

d) if step c) (step S3) is performed positively, then the gear component BT is output as a good part GT (step S4),

e) if step c) is negative, then

f) transferring the corresponding gear component BT into an offline measuring device 20 (step S5);

g) performing an offline measurement oM (step S6) of the corresponding gear component BT in the offline measuring device 20, wherein the offline measurement oM provides at least one measured value Mw;

h) performing a direct or indirect comparison of the measured value Mw with the test value Pw (step S7),

i) if step h) results in a deviation of the measured value Mw from the test value Pw, or a deviation outside of a predetermined limit, then automatically making an adjustment of the inline test iM (step S8).

The following is a detailed discussion of these steps a) to i).

In step a) (step S1), a previously non-toothed component BT can, for example, be provided with teeth by grinding and/or milling. The step a) can, for example, also be used for fine machining of a pre-toothed component BT.

If the inline test device 30 or 140 is arranged in or on the gear-cutting machine 150, the workpiece spindle of the gear-cutting machine 150, in which the gear component BT is clamped during machining, can be transferred in an intermediate step for example from a machining position into a measuring position. In this measuring position, the inline test device 30 or 140 is then used in step b) (step S2) in order to perform an inline test iM in a rapid procedure.

Since, due to the tight time constraints, only a small amount of time is available for performing an inline test iM, such an inline test can always only involve testing a few parameters, variables or values. The result of this inline test iM always provides at least one value, which is referred to here as a test value.

A complete measurement of the gear component BT is only possible in an offline measuring device 20. The result of this offline measurement oM always provides at least one value, which is referred to here as the measured value.

An offline measuring device is referred to here as a measuring device 20 whose clock speed is slower than the clock speed of the production line 100.

In at least some embodiments, the offline measuring device 20 is designed to detect at least the same or comparable parameters, variables or values as the inline test device 30 or 140. If the inline test device 30 or 140 checks the tooth thickness of the gear components BT for example, then the offline measuring device 20 would, for example, measure the tooth thickness of those gear components BT which were not found to be satisfactory in step S3.

In other embodiments, in step b) (step S2) the gear component BT can be re-clamped (i.e. transferred from a first workpiece spindle to a second workpiece spindle) in the gear-cutting machine 150, in order to then carry out the inline test iM. In the case of at least some embodiments in which a re-clamping takes place before testing, the measuring device 30 of the gear-cutting machine 150 may be arranged in a region which is protected from chips and cooling liquid.

If a separate inline test device 140 (see, for example, FIG. 3) is concerned, one partially or fully automated transfer of a component BT after the other is carried out to the inline test device 14 before step b) (step S2) in an intermediate step. This transfer can, for example, occur by means of a robot, a gripping system or a conveyor system. In FIG. 3, this transfer of the components BT is symbolized by the handling connection 15.

Typically, the inline test concerns one of the following test methods (the following listing is to be understood as an open list):

checking the pitch on k tooth flanks, wherein k is <than the number of teeth z of the gear component BT;

checking the helix angle on k tooth flanks, wherein k is <than the number of teeth z of the gear component BT;

checking the tooth thickness of at least one tooth of the gear component BT;

checking the gap width of at least one tooth gap of the gear component BT.

In at least some embodiments, an inline test device 30 or 140, which operates in a contactless manner, may be used. Particularly suitable are optical measuring methods, such as measuring methods using an optical sensor in the switching process. Also suitable are inductive measuring methods.

In step c) (step S3), a comparison is performed, wherein, for the purposes of this comparison, at least one test value Pw for example, which has been determined in the context of the inline test iM, is compared with a default value Vw (e.g. with a setpoint value). In FIG. 4, the comparison in step S3 is symbolized by an OK?, since it is determined here in principle whether the component BT, which was previously tested in step S2, is in order.

In certain embodiments, such a default value Vw can be a setpoint value for example which takes into account corresponding tolerances or a component specification.

In certain embodiments, such a default value Vw can be a setpoint value for example which can be derived from a memory (e.g. from the memory 11).

In other words, it is checked in step c) (step S3) whether the gear component BT corresponds to the predetermined component specification after machining S1. However, it may be taken into account that an inline test iM in some embodiments might be able to provide only one or a few test values PW and to subject them to a comparison in step S3.

Within steps b) and c), a cursory examination and evaluation of the component BT is quasi performed.

As mentioned, the inline test iM provides at least one test value Pw in step b). The concept of the test value PW is to be understood broadly here since, in the inline test, the verification of at least one feature (a parameter, a variable or a value) of the component BT is concerned. The test value Pw therefore does not necessarily have to be a precise value. Instead, in at least some embodiments, this is a qualitative or a first quantitative statement with respect to the component BT.

In the following, a case distinction is then made, as indicated in FIGS. 2 and 3, in such a way that originating from the module iM, which symbolizes the inline test, a solid arrow 17 points downwards in the direction of the offline measuring device 20 from the module iM. If a gear component BT is found to be good (step d) within the scope of the inline test iM, then it is output as a good part GT (step S4). In FIGS. 2 and 3, therefore, a branch with the reference symbol GT is shown on the downward arrow 17.

This branching symbolizes that those components BT, which were found to be good in the context of the cursory test and evaluation, leave the production line 100. In FIG. 4, the discharging or removal of the good part GT corresponds to the step S4.

If a gear component BT is not found to be good within the scope of the inline test iM (step e) or S5), then this gear component BT (until further notice) is classified as a preliminary reject part AT*. In this case, the preliminary reject part AT* is transferred to an offline measuring device 20 in step f) (step S5). In FIGS. 2 and 3, the arrow AT* therefore points in the direction of the offline measuring device 20.

As is shown by way of example in FIGS. 2 and 3, the balance between the number of good parts GT and preliminary reject parts AT* is important for the economical operation of such an overall device 100. If each component BT had to be separated out as a preliminary reject part AT* and had to be measured separately, then the offline measuring device 20 would be used almost like an inline test device. In this case, the clock time of the relatively slow offline measuring device 20 would significantly reduce the throughput of the production line 100.

It is therefore important for a functioning overall device 100 to achieve a useful balance between the two test and measuring methods iM and oM. In order to enable a reliably and robustly working solution within the framework of this approach, at least some embodiments make use of an automated adaptation of the inline test iM in step i) if the offline measurement oM necessitates such an adaptation.

In at least some embodiments in step i), a concrete adaptation of the inline test iM is performed only if the test value Pw of the inline test iM deviates significantly from the measured value Mw of the offline measurement oM. For this purpose, a tolerance window can also be specified here. One such tolerance window can relate to the test value (e.g. Pw ±5%) or the measured value Mw (e.g. Mw ±5%). The method according to at least some embodiments thus makes use of a rapid inline test iM with external matching via an offline measurement oM so as to enable a permanent check of the quality of the inline test iM and, if necessary, a correction thereof.

To enable automated adaptation, a determination is made in step i) as to whether there is a deviation of the measured value from the test value. In FIG. 4, the comparison in step S7 is symbolized by an ok?, since here, in principle, it is again determined in more detail whether the inline test iM of the component BT matches the offline measurement oM.

In step S7, it may be determined in at least some embodiments whether the measured value Mw corresponds to the test value Pw. In this case, the deviation would be equal to zero. However, in practice, minor deviations always occur between the measured values and the test values. Since the components BT can correspond to the specifications in these cases as well, a (tolerance) limit may be set for the step S7, in order to be able to distinguish components BT, which are within the specification, from components BT, since they are outside the specification.

As described initially, a direct comparison or an indirect comparison is carried out as part of step S7, as will be explained in the following with reference to a simple example. If the inline test iM provides, for example, a tooth thickness of 3 mm ±0.2 mm as a test value Pw, and if the offline measurement oM provides a tooth thickness of 3.1 mm as the measured value Mw, then the offline measurement oM would have confirmed the result of the inline test (since Mw=3.1 mm in the test value range is between 2.8 mm and 3.3 mm). If the inline test iM results in the amplitude of the test voltage of a sensor as test value Pw for example, then this test value Pw can be processed in order then to enable a comparison in step S7. This form of the comparison is referred to here as an indirect comparison.

If there is a deviation between the measured value Mw and the test value Pw, the exact (post) test in the offline measuring device 20 has produced a (distinctly) different result from the (preliminary) test in the inline test device 30 or 140. In this case, for example, a provisional reject part AT* can now be found to be good. The method of FIG. 4 branches from step S7 to steps S8 and S10.

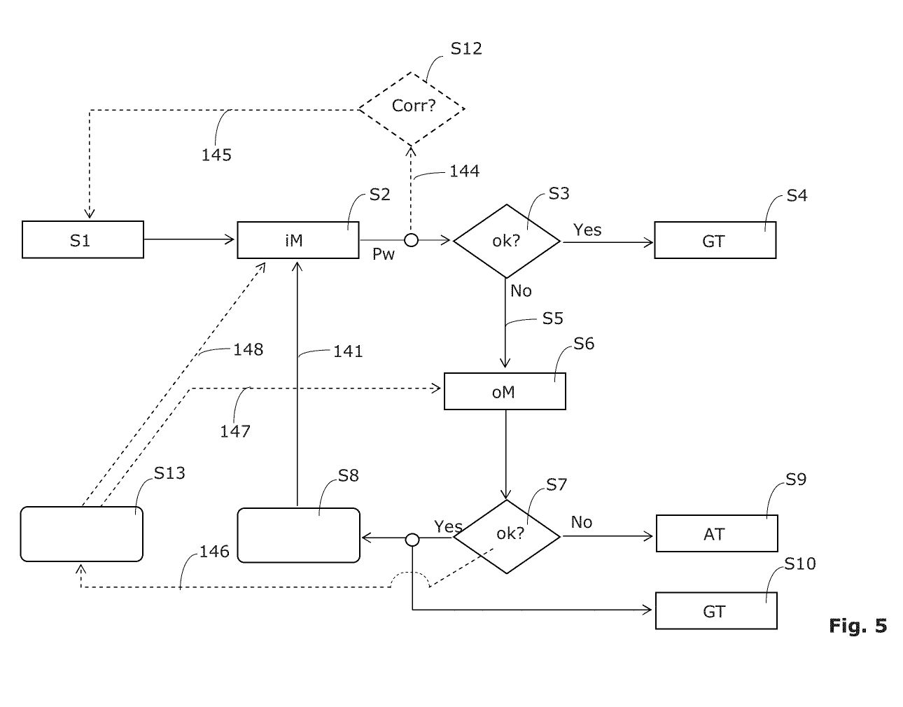

In the event of such a deviation, an automated adaptation of the inline test iM may then be carried out in step i). This adaptation is symbolized in FIGS. 2 and 3 by the dashed arrow 18, which “connects” the offline measurement oM with the inline test iM. In FIG. 4 and FIG. 5, this adaptation is symbolized by the step S8 and the returning loop 141.

The term “automated adjustment” may include various embodiments, as will be explained in the following.

Automated adaptation is understood for example as being the (post) adjustment or calibration of the inline test device 30 or 140. If, for example, a sensor of the inline test device 30 or 140 emits a voltage signal whose amplitude changes in proportion to a measured value on the gear component BT, for example, a precise angular value can be assigned to a signal of 2 volts. This precise angular value is then based on at least one (post) measurement in the offline measuring device 20.

The automated adaptation can be used, for example, for adjusting the sensitivity or for calibrating the inline test device 30 or 140, or the adaptation can be used as a correction factor in a table lookup in an evaluation table.

In at least some embodiments, the deviation of the inline test iM and the offline measurement oM is evaluated in step S8, before the automated adaptation then takes place.

If the evaluation carried out over a series of measurements on several components BT shows a linear deviation for example, then a linear correction value can be transferred to the inline test device 30 or 140 as part of the automated adaptation, for example. This correction value is then added up or subtracted as a linear correction value during the execution of future inline tests iM or during the computational processing of the test values Pw.

In at least some embodiments, a computational analysis of the deviations can take place in step S8. For example, the differences between the results of the testing means 30 or 140 and of the measuring device 20 can be evaluated in order to carry out an automated adjustment based on this analysis.

The automated performance of an adaptation of the inline test iM (step S8) can have an influence either directly on the inline test device 30 or 140 (by readjusting it for example, or by changing the sensitivity of a sensor of the measuring device 30 or 140 for example), or the adaptation is made indirectly in such a way that the evaluation (for example, the computational processing of the test values Pw) of the inline tests iM is adjusted purely mathematically (e.g. by a correction value or factor).

A subsequent step may follow in at least some embodiments, which allows the component BT which has just been measured precisely in step S6 to be subsequently classified as a good part GT (step S10) or to confirm the classification as a provisional reject part AT* (step S9). This subsequent step is symbolized in FIGS. 2 and 3 by a switch 19 on the left of the offline measuring device 20. If the classification as the provisional reject part AT* has been confirmed, this component BT is finally treated as a reject part and the reference character AT is used in the figures.

Optionally, the method may comprise a further loop with elements 142, S11 and 143. Since it is an optional embodiment, the corresponding elements 142, S11, and 143 are shown in a dashed line in FIG. 4. If the process branches from step S7 to step S9, a test routine in step S11 may be performed. This test routine can be designed to analyze the final parts AT (computationally).

The loop with the elements 142, S11 and 143 can also be applied at a different point in the flowchart of FIG. 4 or 5. A correction in step S11 may be useful, for example, both in the case of an “established as good” condition and in the case of a sorting-out of the component BT.

A threshold value may be used in step S11. If the threshold value is exceeded, the method can intervene in the actual processing step S1 in order to adapt the machining. This makes it possible to ensure that the process does not produce an unnecessarily large number of reject parts AT.

In addition or alternatively, such a test routine can also be used in the region of step S3 (e.g. at step S5 or before step S3, as shown in FIG. 5). Thus, embodiments are possible in which a test routine (step S11) is executed in the area of the step S7, in which a test routine (not shown) is executed in the area of the step S3, or in each case a test routine is executed in the area of the step S3 and the step S7.

The final separation of good parts GT and reject parts AT is shown in FIGS. 4 and 5 by the steps S10 and S9.

FIG. 5 shows the steps of a further embodiment by means of a further flow chart. Reference is made hereinafter, among others, to this FIG. 5. Unless otherwise stated, reference is made to the explanations in FIG. 4 with regard to steps S1, S2, S3, S4, S5, S6, S7 and S8. In the following, the differences are primarily discussed.

Other than in FIG. 4, an optional correction loop with the elements 144, S12 and 145 in the region of the step S3 is applied in FIG. 5. This correction loop may be similar to the optional correction loop with the elements 142, S11 and 143 of FIG. 4.

In addition to the features of FIG. 4, the method of FIG. 5 includes means for the analysis of deviations. In certain embodiments, these means can comprise the elements 146, S13, for example, as well as at least one of the elements 147, 148. In step S13, a computational analysis of the deviations is made using a software module.

If this analysis requires adaptations, an adaptation of the test criteria of the inline test iM and/or the offline measurement oM can be carried out, as indicated by the paths 147, 148 in FIG. 5. The change in the tolerance limits can be included for example in the adaptation of the test criteria. However, a change in the test method can also occur, as explained in the following simplified example.

If, for example, the inline test iM is originally designed to perform a non-contact pitch measurement on only three tooth flanks of the component BT in step S2, then the change in the test method can intervene in step S2 in that more than three tooth flanks are now included in the pitch measurement.

Optionally, in at least some embodiments, additional process variables are included in steps S8 and/or S13. This is also explained in the following with reference to a simple example.

As a process variable, in step S1 or in step S2 for example, the temperature of the component BT can be measured and stored. Measuring and storing the temperature provides an additional parameter which can be considered for the inline test iM and/or the offline measurement oM.

In this way, it can be determined whether an increase in the number of the reject parts AT* or AT results from a specific temperature of the component BT.

If an analysis of this process variable indicates that increased rejects AT* or AT are produced, while the offline measurement oM has confirmed the inline test iM, it can be concluded for example that the machining process S1 produces real rejects from the particular temperature. In this case, a corrective influence can be made on the machining process in step S1 via the elements 142, S11, 143 and/or 144, S12, 145, for example.

If an analysis of this process variable indicates that increased rejects AT* or AT are detected and the offline measurement oM has refuted the inline test iM, then it can be concluded for example that the inline test iM results in incorrect results because of an excessively high temperature of the component BT. In this case, an adaptation of the measurement strategy of the inline test iM can be carried out for example via the path 148.

State variables or values of the component BT (e.g. the temperature of the component) and/or the machine 150 (e.g. the temperature of the workpiece spindle of the machine 150) and/or the measuring device 30 or 140 (e.g. the temperature of the workpiece measuring spindle of the measuring device 30 or 140) are designated in this case as process variables.

As may be recognized by those of ordinary skill in the pertinent art based on the teachings herein, numerous changes and modifications may be made to the above described and other embodiments of the present invention without departing from the spirit of the invention as defined in the claims. Accordingly, this detailed description of embodiments is to be taken in an illustrative, as opposed to a limiting sense.

What is claimed is:

1. A method for the automated machining of gear components in a device, comprising the following steps:
a) machining a gear component in a gear-cutting machine,
b) performing an inline test of the gear component after said machining and obtaining by the inline test at least one test value of at least one feature of the gear component, wherein the inline test is performed in an inline test device located either in or on the gear-cutting machine or separate from the gear-cutting machine,
c) comparing the at least one test value with at least one default value,
d) when said comparison performed in step c) is positive, outputting the gear part as a good part,
e) when said comparison performed in step c) is negative,
(i) transferring the gear component to an external measuring device adapted to perform an offline measurement,
(ii) performing the offline measurement of the gear component and obtaining by the offline measurement at least one measured value of the at least one feature of the gear component,
(iii) comparing the at least one measured value with the at least one test value,
(iv) when said comparison performed in step (iii) indicates a deviation of the at least one measured value from the at least one test value or a deviation of the at least one measured value from the at least one test value outside of a predetermined tolerance or limit, automatically making an adaptation of the inline test.

2. A method according to claim 1, including performing the inline test in or near the gear-cutting machine.

3. A method according to claim 1, including performing the inline test in a measuring device connected by a handling connection to the gear-cutting machine.

4. A method according to claim 1, wherein the device operates in a clock-based manner.

5. A method according to claim 4, further including the device predetermining a basic clock rate and performing the inline test for a duration which is shorter than the basic clock rate or corresponds to the basic clock rate.

6. A method according to claim 5, including performing the offline measurement for a duration which is longer than the basic clock rate.

7. A method according to claim 1, further comprising, in step e) or after step e), preliminarily classifying the gear component as a reject part.

8. A method according to claim 1, further comprising after step iv), when no deviation of the at least one measured value from the at least one test value or a deviation of the at least one measured value from the at least one test value within a predetermined tolerance or limit has been indicated, outputting the gear component as a good part.

9. A method according to claim 1, wherein step iv) further comprises one or more of:
readjusting the inline test device;
gauging the inline test device;
calibrating the inline test device;
adjusting a computational preparation or processing of the at least one test value;
adjusting a threshold value of the inline test device;
adjusting an evaluation or processing of the at least one test value; or
adjusting test criteria of the inline test device.

10. A device for the automated machining of gear components, comprising:
a gear-cutting machine configured for machining a plurality of gear components,
a first measuring device adapted to perform an inline test of each gear component previously machined in the machine and obtain at least one test value of at least one feature of said gear component,
a second measuring device adapted to perform an offline measurement of one or more of gear components previously tested in the first measuring device and to obtain at least one measured value of the at least one feature of the one or more gear components,
a loop, and
software, adapted to perform the following steps for a gear component:
performing a first comparison comparing the at least one test value therefor with at least one default value,
triggering an outputting of the gear component as a good part if the first comparison is positive,
transferring the gear component into the second measuring device,
performing a second comparison comparing the at least one measured value therefor with the at least one test value therefor, and
automatically adapting one or more of the inline test or the first measuring device via the loop if the second comparison indicates a deviation of said at least one measured value from the at least one test value or a deviation of said measured value from the at least one test value outside a predetermined tolerance or limit.

11. A device according to claim 10, wherein the software is part of a controller, or the software is installed in a computer which is connected via a communication link to the device.

12. A device according to claim 10, wherein the first measuring device is located in or near the gear-cutting machine.

13. A device according to claim 10, wherein the first measuring device is located separate from the gear-cutting machine and connected via a handling connection to the gear-cutting machine.

14. A device according to claim 10, wherein the device is configured to operate in a clock-based manner.

15. A device according to claim 14, wherein the device is configured to predetermine a basic clock rate and perform the inline test for a duration which is shorter than the basic clock rate or which corresponds to the basic clock rate.

16. A device according to claim 15, wherein the device is configured to perform the offline measurement for a duration which is longer than the basic clock rate.

17. A device according to claim 10, wherein the device is adapted to output one or more of the plurality of gear components preliminarily as a reject part.
